(19) United States
(12) Patent Application Publication
(10) Pub. No.: US 2005/0220702 A1
(43) Pub. Date: Oct. 6, 2005

(54) High flow rate gaseous reactant supply

(76) Inventors: Robert O. Martin, Edmond, OK (US); Charles A. Natalie, Edmond, OK (US)

Correspondence Address: LAW OFFICE OF STANLEY K. HILL, PLC, P.O. BOX 52050, MINNEAPOLIS, MN, 55402, US

(21) Appl. No.: 10/817,740

(22) Filed: Apr. 2, 2004

(51) Int. Cl. C01G 23/047

(52) U.S. Cl. 423/613

(57) ABSTRACT

A gaseous reactant supply apparatus for turning high flow rates of gaseous supply approximately 90 degrees and providing a uniform distribution of gaseous supply. The gaseous supply passes through a venturi throat. Straightening vanes can be positioned inside the venturi throat to reduce rotational motion the gaseous reactant supply may have upon entering the venturi throat. The gaseous reactant supply apparatus exhibits lower pressure drops than exhibited by apparatus of the prior art.

### FIELD OF THE INVENTION

The present invention generally relates to methods and apparatus for supplying gaseous reactants to a reaction chamber at high flow rates. More particularly, the present invention includes methods and apparatus useful for reacting high flow rates of oxygen and titanium tetrachloride gas in a tubular reactor at high temperature to produce titanium dioxide.

### BACKGROUND AND SUMMARY OF THE INVENTION

The chloride method for producing titanium dioxide typically involves reacting oxygen and titanium tetrachloride gas in a tubular reactor at high flow rates. A high temperature oxidation reaction takes place in the reactor whereby solid titanium dioxide particles are produced. Additives in small amounts are used to control the particle size and structure.

Conventionally, a preheated oxygen stream (for example, at a temperature of from about 1500° F. to about 1800° F.) is combusted in part with a supplemental hydrocarbon fuel to further increase the temperature of the oxygen stream to a final temperature of from about 3000° F. to about 3800° F., just prior to reacting the oxygen with the titanium tetrachloride gas. Hydrocarbon fuels in either the vapor phase or liquid phase can be used for this purpose. Using liquid phase fuels provides a number of advantages, including but not limited to, providing safer means to deliver the fuel to the reaction zone; enabling the use of low-grade, less costly fuel; and providing the ability to deliver additives to the reaction zone in a consistent manner by dissolving the additives in the fuel. However, problems can arise when using liquid fuel injection systems in the production of titanium dioxide. For example, the fuel has to be injected into the hot gas stream in such a way that the heat from the combustion of the fuel does not destroy the injection nozzles or the reactor walls. This requires that the oxygen stream be uniform in flow so that the liquid fuel is not forced in the direction of the reactor walls.

In systems where the oxygen has to turn approximately 90 degrees in the region where the fuel is injected, special oxygen supply apparatus have been used to realign the oxygen flow so that it is uniform. Preferably, this is done without a large pressure drop across the apparatus, as this would increase the cost of handling the hot oxygen supply. One such oxygen supply apparatus is taught in U.S. Pat. No. 6,350,427 issued to Yuill et al. (“Yuill”). The Yuill oxygen supply apparatus employs a plenum with two stages of different size that force the gases to follow a tortuous path, in order to deliver a uniform flow of oxygen in the reactor on injection. As oxygen flow rate requirements have increased, however, it has become correspondingly more difficult to provide a uniform oxygen flow through the center of the reactor with the Yuill apparatus. Accordingly, there exists a need for an oxygen supply apparatus that provides a more uniform flow of oxygen at the higher oxygen flow rates desired today.

The present invention thus provides improved methods and apparatus for producing titanium dioxide, in particular, by providing in a first aspect an improved gaseous reactant supply apparatus for turning a high flow rate of a gaseous reactant approximately 90 degrees and delivering the gaseous reactant to a reaction chamber with a substantially uniform flow, while in the process exhibiting a lower pressure drop than exhibited by apparatus of the prior art. In a preferred embodiment, the gaseous reactant is oxygen. In another preferred embodiment, the reaction chamber is a tubular reactor adapted for reacting heated oxygen and heated titanium tetrachloride to produce titanium dioxide.

Gaseous reactant supply apparatus according to the present invention broadly comprise a plenum housing having an interior surface; a venturi throat located in the plenum housed by the plenum housing, the venturi throat having an upstream end and a downstream end; and a gaseous reactant supply inlet approximately perpendicular to the venturi throat. The interior of the plenum housing defines a flow space between the upstream end of the venturi throat and the interior surface of the plenum housing, the flow space being of sufficient size to allow a gaseous reactant to flow freely there-through from the gaseous reactant inlet to the upstream end of the venture throat. Preferably, the gaseous reactant supply inlet is positioned closer to the downstream end of the venturi throat than to its upstream end. In a further embodiment, the venturi throat comprises straightening vanes adapted to reduce rotation of a gaseous reactant flow through the venturi throat. In an additional embodiment, the plenum housing comprises an interior lining adapted to withstand gaseous reactants at up to at least about 1750° F. and insulation adapted to reduce heat loss from the plenum interior.

Gaseous reactant supply apparatus according to the present invention allow high flow rates of gaseous reactants to be supplied with substantially uniform flow using less pressure than is currently required by supply apparatus of the prior art. In a preferred embodiment, the present invention exhibits a pressure drop of less than about 2 psi between the inlet and the exit when the inlet introduces a gaseous reactant flow at a rate of at least about 400 standard cubic feet per minute. In another preferred embodiment, the pressure drop is less than about 1.5 psi. Preferably, the introduced gaseous reactant flow rate is at least about 500 standard cubic feet per minute, and more preferably at least about 750 standard cubic feet per minute.

In a second aspect, the present invention provides improved methods for introducing a high flow rate of oxygen to a reaction chamber. According to the methods of the present invention, a gaseous reactant is introduced into a plenum housing through a gaseous reactant supply inlet. In a preferred embodiment, the gaseous reactant is introduced tangentially. The plenum communicates with a venturi throat located in the interior of the plenum housing, the venturi throat having an upstream end and a downstream end. The plenum housing and venturi throat define a flow space between the inside surface of the plenum housing and the upstream end of the venturi throat. The gaseous reactant passes through the flow space and into the upstream end of the venturi throat. The gaseous reactant then passes through the venturi throat, exiting the venturi throat through the downstream end. Upon exiting the venturi throat, the flow of gaseous reactant is substantially uniform. In a preferred embodiment, the gaseous reactant passes through straightening vanes located in the venturi throat. In a preferred embodiment, the gaseous reactant is oxygen. In a preferred embodiment, the oxygen is reacted with a hydrocarbon fuel upon exiting the venturi throat, raising the temperature of the remaining unreacted oxygen to a temperature of from about 3000° F. to about 3800° F. In a still further embodiment, the heated oxygen is reacted with gaseous titanium tetrachloride in a subsequent reactor to produce titanium dioxide.

Additional features and advantages of the present invention will be readily apparent to those skilled in the art upon a reading of the description of preferred embodiments which follows when taken in conjunction with the accompanying drawings.

### DESCRIPTION OF THE DRAWINGS

The present invention is illustrated by way of example in the following drawings in which like references indicate similar elements. The following drawings disclose various embodiments of the present invention for purposes of illustration only. The drawings are not intended to limit the scope of the invention.

FIG. 1 shows a three dimensional view of a gaseous reactant supply apparatus according to the present invention.

FIG. 2 shows a cut-away view of the gaseous reactant supply apparatus shown in FIG. 1.

FIG. 3 shows the cut-away view of FIG. 2 rotated 90 degrees.

### DESCRIPTION OF PREFERRED EMBODIMENTS

In the following detailed description of preferred embodiments of the present invention, reference is made to the accompanying Drawings, which form a part hereof, and in which are shown by way of illustration specific embodiments in which the present invention may be practiced. It should be understood that other embodiments may be utilized and changes may be made without departing from the scope of the present invention.

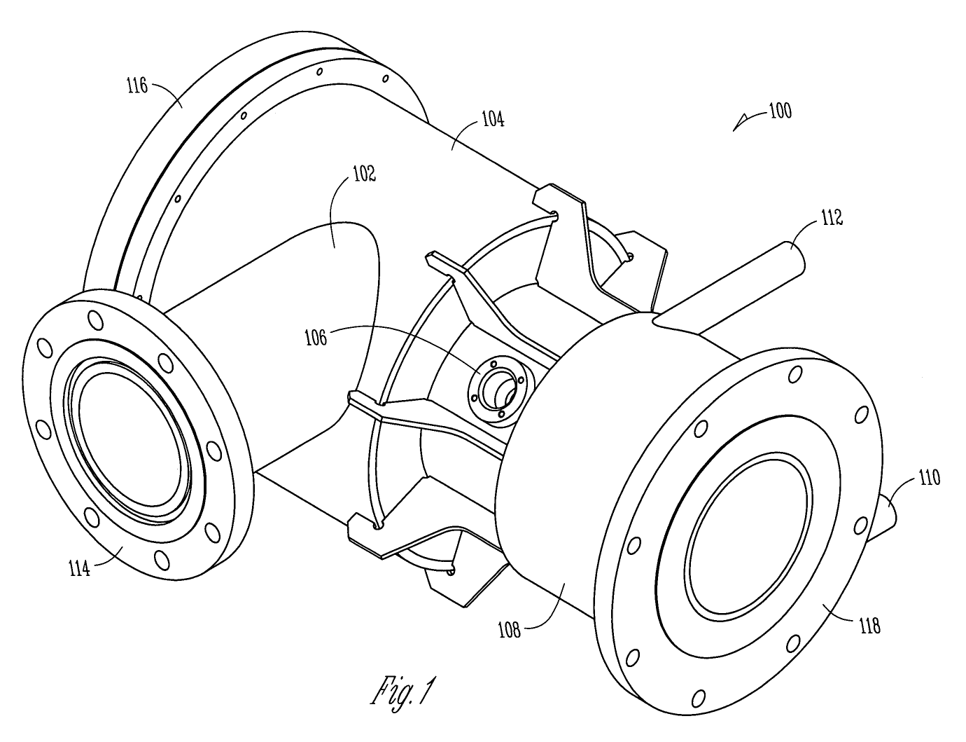

Gaseous reactant supply apparatus of the present invention are particularly useful for turning a high flow rate gaseous reactant supply stream approximately 90 degrees and introducing a substantially uniform distribution of gaseous reactant into a reaction chamber. In a preferred embodiment, the gaseous reactant is oxygen and the reaction chamber is a tubular reactor such as those known in the art to be useful for reacting oxygen and titanium tetrachloride to produce titanium dioxide. Referring now to FIGS. 1 through 3 of the drawings, a gaseous reactant supply apparatus of the present invention for injecting high flow rates of oxygen into a tubular reactor is illustrated. The tubular reactor is used in producing titanium dioxide from oxygen and titanium tetrachloride gas. The tubular reactor can be of any known reactor design including those that are cooled with water or other heat exchange medium, those which are not cooled, those that are formed of a porous medium, etc. By “high flow rate”, it is meant that gaseous reactant supply streams in accordance with the present invention will have a flow rate of at least about 400 cubic feet per minute, preferably at least about 500 cubic feet per minute, and more preferably at least about 750 cubic feet per minute. Typically, the gaseous reactant flow rate will not exceed about 3000 cubic feet per minute.

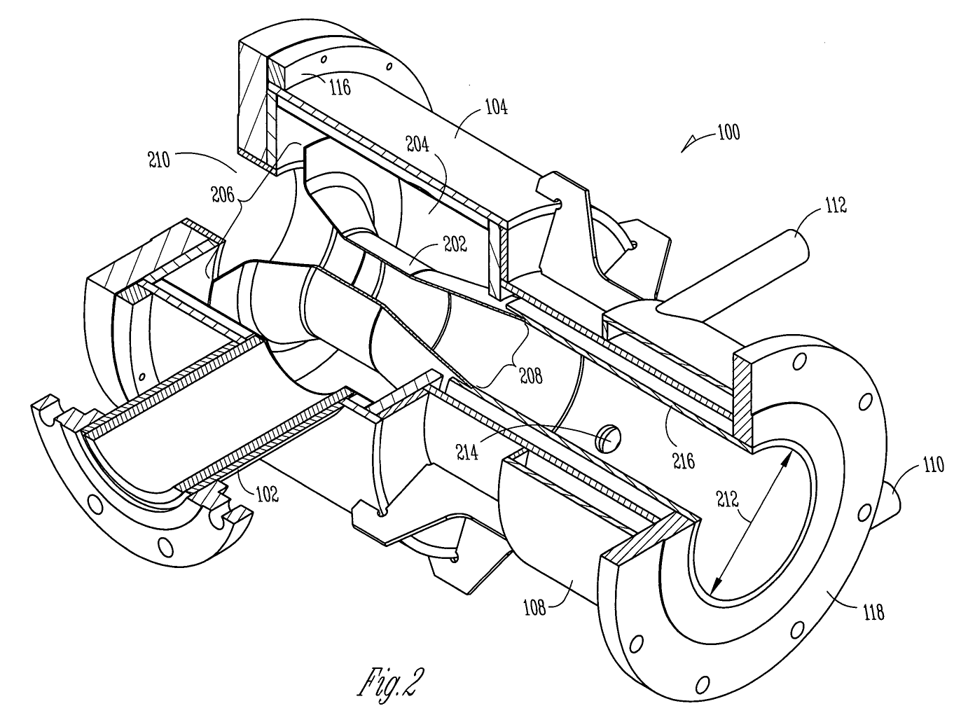

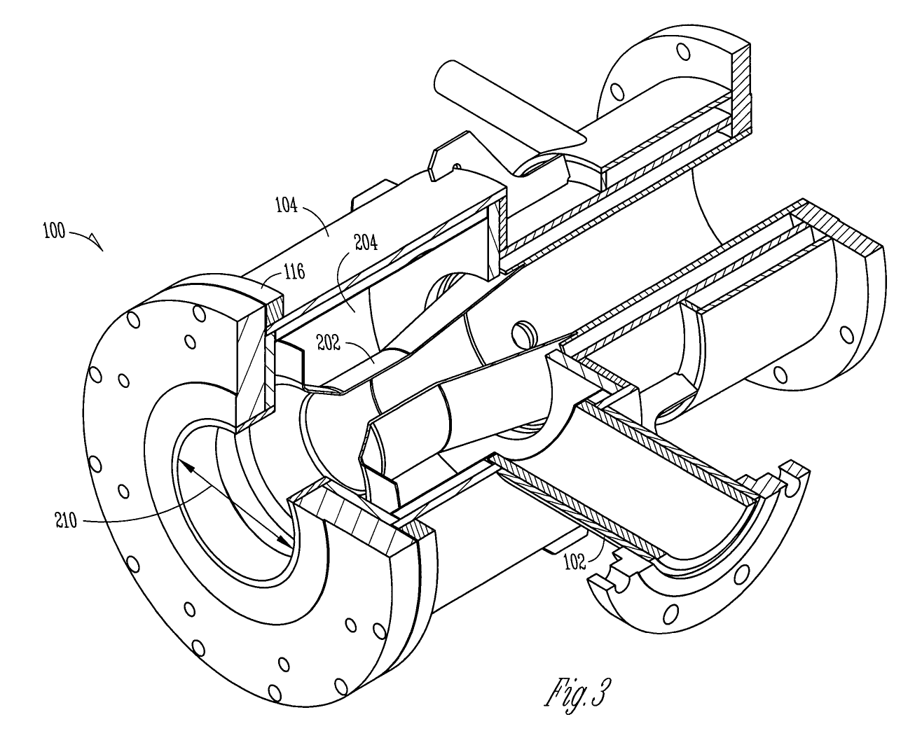

FIG. 1 shows a three-dimensional view of a preferred embodiment 100 of an oxygen supply apparatus according to the present invention. The oxygen supply apparatus 100 comprises an oxygen inlet 102, a plenum housing 104, mounting surfaces 106 for attaching fuel injectors to the oxygen supply apparatus 100, a cooling jacket 108, a cooling water inlet 110, and a cooling water outlet 112. The oxygen supply apparatus 100 further comprises a first flange 114 for attaching the oxygen supply apparatus 100 to an oxygen supply (not shown), a second flange 116 for attaching the oxygen supply apparatus 100 to a scour media supply (not shown), and a third flange 118 for attaching the oxygen supply apparatus 100 to a titanium tetrachloride injection spool or a tubular reactor (neither shown). Preferably, the plenum housing 104 encloses a generally cylindrical plenum (and an annular flow space with the venturi throat within the plenum) and the oxygen inlet 102 is situated to provide for tangential entry of the oxygen from the inlet 102 into the plenum enclosed by plenum housing 104, as suggested by FIG. 1 and better illustrated in FIGS. 2 and 3.

FIG. 2 shows a cut-away view of the oxygen supply apparatus shown in FIG. 1. As shown in FIG. 2, the oxygen supply apparatus 100 comprises a venturi throat 202. The venturi throat 202 is positioned in the plenum 204 housed by the plenum housing 104. The venturi throat 202 has an upstream end 206 and a downstream end 208. Preferably, the oxygen inlet 102 is positioned closer to the downstream end 208 than the upstream end 206. FIG. 3 shows the same cut-away view as FIG. 2 except that the view in FIG. 3 has been rotated 90 degrees.

In operation, the oxygen supply apparatus 100 is utilized to inject a stream of heated oxygen at a high flow rate into a tubular reactor where titanium dioxide is produced. The high flow rates of oxygen can be injected with lower pressure drops than can be obtained by using apparatus of the prior art. The lower pressure drops enabled by the oxygen supply apparatus 100 allow equivalent flow rates of heated oxygen to be produced at lower pressures than the pressures needed when using apparatus of the prior art. Additionally, higher flow rates of oxygen can be obtained than the flow rates attainable using apparatus of the prior art at equivalent pressures.

The oxygen stream enters the plenum 204 through the oxygen inlet 102. As the oxygen stream enters the plenum 204, the oxygen will typically be at a temperature of between about 950° C. and about 1000° C. The plenum housing 104 has an interior surface adapted to withstand temperatures up to at least about 1000° C. In a preferred embodiment, the plenum housing 104 also comprises insulation adapted to reduce heat loss from the plenum interior. The interior surface of the plenum housing 104 and the venturi throat 202 define a generally annular flow space there-between, the flow space being sufficient to allow the oxygen to flow freely through the space from the inlet 102 to an upstream end 206 of the venture throat 202. When the oxygen inlet 102 is tangential to the plenum 204 and closer to the downstream end 208 of the venturi throat 202 as is shown in FIG. 2, the oxygen will generally follow a spiral or vortex path around the venturi throat 202 until it reaches the upstream end 206 of the venturi throat 202. In any case, the oxygen passes through the flow space and enters the venturi throat 202 at the upstream end 206 of the venturi throat 202. Provision has also been made in the illustrated preferred embodiment for scour media to enter the plenum housing 104 through an opening 210 in the second flange 116, and the scour media also passes with the oxygen into the upstream end 206 of the venturi throat 202. For applications not requiring scour media, the second flange 116 can be replaced by a solid plenum housing wall.

The oxygen passes the venturi throat 202 and then exits the venturi throat 202 at the downstream end 208, continuing to flow through the oxygen supply apparatus 100 toward the exit 212 of the oxygen supply apparatus 100. Straightening vanes can be positioned in the venturi throat 202 to reduce the rotational motion of the oxygen coming into and passing through the venturi throat.

Because the oxygen supply apparatus 100 produces an oxygen flow exiting the venturi throat 202 that is substantially uniform through the cross-section, it is an excellent place for the injection of liquid fuels. One or more fuel inlets 214 are thus preferably positioned just downstream of the venturi throat's downstream end 208. Fuel is injected into the oxygen supply apparatus 100 through the fuel inlets 214 and the fuel reacts with some of the oxygen to generate heat. Preferably, the fuel is a hydrocarbon fuel. In one preferred embodiment, the fuel is toluene that is sprayed into the apparatus 100 through the fuel inlets 214 by fuel injectors mounted on the mounting surfaces 106. The oxygen is present in stoichiometric excess. Thus, the fuel is substantially consumed by virtue of its reaction with oxygen and the heat generated heats the remaining oxygen. Preferably, the heated oxygen will reach a temperature of at least about 3000° F. Typically, the temperature of the heated oxygen will not exceed about 3800° F. The heated oxygen passes through the exit 212 of the oxygen supply apparatus 100 and into a titanium tetrachloride injection spool or a tubular reactor (not shown).

Computational Fluid Dynamics (“CFD”) has been used to calculate the pressure drop between the point at which oxygen flows passed the first flange 114 and the point at which the oxygen flows out through the exit 212. The CFD calculations show that oxygen supply apparatus in accordance with the present invention can be produced that have pressure drops that are from about 40 percent to about 60 percent lower than the pressure drops exhibited by oxygen supply apparatus taught in U.S. Pat. No. 6,350,427 issued to Yuill et al. (“Yuill”). Preferably, oxygen supply apparatus of the present invention exhibit pressure drops of less than about 2 psi. More preferably, oxygen supply apparatus of the present invention exhibit pressure drops of less than about 1.5 psi.

The oxygen supply apparatus 100 also preferably comprises a cooling jacket 108 used for keeping the temperature at the outer surface of the apparatus's inner liner 216 to less than about 2000° F., and preferably less than about 1800° F. The inner liner 216 is exposed to the flame resulting from the reaction of oxygen and the fuel. Keeping the temperature of the liner 216 down can prolong the life of the inner liner 216. The cooling jacket 108 of the oxygen supply apparatus 100 is separated from the inner liner 216 by a space typically containing air. Heat is transferred to the cooling jacket 108 where it heats the water passing through the cooling jacket 108. Water enters the cooling jacket 108 via the water inlet 110 and exits the cooling jacket via the water exit 112. Water cooling jackets and other cooling mechanisms are known in the art and any known mechanism capable of keeping the surface temperature of an inner lining down may be advantageously utilized in conjunction with gaseous reactant supply apparatus of the present invention.

In the process for producing titanium dioxide, the oxygen flow exiting an oxygen supply apparatus will generally pass, as already mentioned, through a titanium tetrachloride injection spool on its way to a reactor (for example a tubular reactor). The titanium tetrachloride injection spool injects titanium tetrachloride and the injected titanium tetrachloride reacts with the heated oxygen in the reactor to produce the titanium dioxide. The titanium tetrachloride gas is typically preheated to a temperature of at least about 350° F. and preferably at least about 750° F. The titanium tetrachloride typically is preheated to a temperature no greater than about 1800° F. and preferably no greater than about 1100° F. Aluminum chloride can be added to the preheated titanium tetrachloride to enhance rutilization of the produced titanium dioxide and make it more durable, as is known in the art. Processes according to the present invention for producing titanium dioxide are generally carried out in the reactor at a pressure of at least about 2 psig and a temperature of at least about 2200 degrees F.

As will be understood by those skilled in the art, while the description herein has focused on the reaction of oxygen with titanium tetrachloride to produce titanium dioxide according to the well-known chloride process, the processes and apparatus of the present invention can be utilized for providing a variety of gaseous reactants at high flow rates and temperatures and for carrying out other sorts of reactions. Examples would include reacting preheated oxygen with other preheated metal chlorides such as silicon tetrachloride, zirconium tetrachloride, aluminum tetrachloride and the like. The processes and apparatus of the present invention for providing gaseous reactants make it possible to carry out these and other reactions at low pressure drops with a substantially uniform distribution and better mixing of the reactants in the reactors.

While the present invention has been described in detail with respect to specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and by equivalents thereto.

1. A gaseous reactant supply apparatus, comprising:
a plenum housing having an interior surface;
a gaseous reactant inlet to the plenum housing; and
a venturi throat having an upstream end and a downstream end, the venturi throat positioned inside the plenum housing such that there exists sufficient space between the venturi throat and the plenum housing's interior surface to allow a gaseous reactant to flow freely from the gaseous reactant inlet to the upstream end of the venture throat.

2. The apparatus of claim 1, wherein the interior surface of the plenum housing and the venturi throat define a generally annular-shaped plenum.

3. The apparatus of claim 2, wherein the gaseous reactant inlet is tangential to the plenum.

4. The apparatus of claim 1, wherein the gaseous reactant inlet is positioned closer to the downstream end of the venturi throat than the upstream end of the venturi throat.

5. The apparatus of claim 1, further comprising straightening vanes positioned within the venturi throat.

6. The apparatus of claim 5, wherein the interior surface of the plenum housing and the venturi throat define a generally annular-shaped plenum.

7. The apparatus of claim 6, wherein the gaseous reactant inlet is tangential to the plenum.

8. The apparatus of claim 5, wherein the gaseous reactant inlet is positioned closer to the downstream end of the venturi throat than the upstream end of the venturi throat.

9. The apparatus of claim 1, further comprising means for injecting hydrocarbon fuel into the gaseous reactant exiting the downstream end of the venturi throat.

10. The apparatus of claim 9, further comprising a protective inner lining suited to the temperatures found adjacent and downstream of an injection point of the hydrocarbon fuel and a cooling circuit for removing heat from the apparatus adjacent and downstream of the injection point.

11. A process for turning a high flow rate of gaseous reactant about 90 degrees, comprising the steps of:
introducing the gaseous reactant into a plenum housing through an inlet;
passing the gaseous reactant through a plenum housed by the plenum housing and into a venturi throat having an upstream end and a downstream end, wherein the gaseous reactant enters the venturi throat at the upstream end, and wherein the venturi throat is aligned approximately perpendicular to the inlet;
passing the gaseous reactant through the venturi throat, wherein the gaseous reactant exits the venturi throat at the downstream end.

12. The process of claim 11, wherein the gaseous reactant is oxygen.

13. The process of claim 11, wherein the gaseous reactant is introduced into the plenum at a rate of at least about 400 standard cubic feet per minute.

14. The process of claim 11, wherein the gaseous reactant is introduced into the plenum at a rate of at least about 500 standard cubic feet per minute.

15. The process of claim 11, wherein the gaseous reactant is introduced into the plenum at a rate of at least about 750 standard cubic feet per minute.

16. The process of claim 11, wherein the process produces a pressure drop of less than about 2 psi.

17. The process of claim 11, wherein the process produces a pressure drop of less than about 1.5 psi.

18. The process of claim 11, further comprising using straightening vanes in the venturi throat for reducing rotational motion of the gaseous reactant as it flows through the venturi throat.

19. The process of claim 11, wherein the gaseous reactant introduced into the plenum is oxygen at a temperature of from about 950° C. to about 1000° C.

20. The process of claim 19, further comprising reacting a portion of the oxygen exiting the downstream end of the venturi throat with a fuel, to thereby heat the unreacted oxygen to a temperature of at least about 3000° F.

21. The process of claim 20, wherein the fuel is a hydrocarbon fuel.

22. The process of claim 21, wherein the fuel is toluene.

23. The process of claim 20, wherein the unreacted oxygen is heated to a temperature of no more than about 3800° F.

24. The process of claim 20, further comprising reacting the unreacted, hot oxygen with titanium tetrachloride to produce titanium dioxide.
